(19) United States
(12) Patent Application Publication
(10) Pub. No.: US 2021/0406645 A1
(43) Pub. Date: Dec. 30, 2021

(54) Method for Low Resource and Low Power Consuming Implementation of Nonlinear Activation Functions of Artificial Neural Networks

(71) Applicants: ASELSAN ELEKTRONIK SAN. VE TIC. A. S., Ankara (TR); ORTA DOGU TEKNIK UNIVERSITESI, Ankara (TR)

(72) Inventors: SONER YESIL, Ankara (TR); CANSU SEN, Ankara (TR); ALI OZGUR YILMAZ, ANKARA (TR)

(73) Assignees: ASELSAN ELEKTRONIK SAN. VE TIC. A. S., ANKARA (TR); ORTA DOGU TEKNIK UNIVERSITESI, ANKARA (TR)

(21) Appl. No.: 17/229,894

(22) Filed: Apr. 14, 2021

(30) Foreign Application Priority Data
Jun. 29, 2020 (TR) 2020/10217

(51) Int. Cl. G06N 3/04; G06N 3/08; G06F 5/01

(52) U.S. Cl. CPC G06N 3/0481; G06F 5/01; G06N 3/08

(57) ABSTRACT

A method does not use high resource and high power consuming memory elements (LUT, Block RAM, etc.) or a distributed RAM in an implementation of nonlinear activation functions of artificial neural networks (ANN), eliminating a need for multiplication elements completely by using shift operations. Since each neuron includes an activation function, eliminating a multiplication element saves significant amount of resource and power in an implementation of the ANN.

### CROSS REFERENCE TO THE RELATED APPLICATIONS

This application is based upon and claims priority to Turkish Patent Application No. 2020/10217, filed on Jun. 29, 2020, the disclosure of which is incorporated herein by reference in its entirety.

### TECHNICAL FIELD

The invention relates to a method for approximating nonlinear activation functions of artificial neural networks (ANN) by piecewise linear functions.

The invention specifically relates to a method which does not use high resource and high power consuming memory elements in the implementation of nonlinear activation functions of artificial neural networks, and eliminating the need for multiplication elements by using shift operations. Since each neuron includes an activation function, eliminating the multiplication element saves significant amount of resource and power in the implementation of artificial neural networks.

### BACKGROUND

A neural network is a series of algorithms that endeavors to recognize underlying relationships under a set of data by means of a process that mimics the way the human brain operates. The manner in which simple biological neural system operates can be mimicked by neural networks. Mimicked neural cells comprise neurons and these neurons form the network by connecting to each other in various ways. These networks have the capacity to learn, store in the memory and discover the relation between data. Neural networks can adapt to changing input, so that the network generates the best possible result without a need to redesign the output criteria.

Artificial neural networks comprise of an input layer, an output layer and hidden layers.

Input layer: It is the layer where the features of the sample received into a network and desired to be learned is provided as input. The number of neurons must be as many as the number of the features of samples to be trained on the input layer.

Output Layer: It is the layer where the class information or label value of the samples desired to be learned in the artificial network are calculated as output.

Hidden Layers: They are the layers between the input layer and the output layers. The number of layers and the number of neurons on layers may change according to problems. On these layers, forward calculation and backward error propagation are performed. A high number of layers result in a complexity of calculation and an increase in the calculation time. In complex problems, the number of layers and the number of neurons on layers are generally high for the solution of the problem.

Weights are parameters which are used for setting the impact of the input on the output. Weights are multiplied by input values and transmitted forward.

An Activation Function generates the activation output of the neuron which corresponds to this input by processing the net value coming to the cell. Selection of the activation function according to the problem significantly affects the performance of the network and the rate of success.

The input layer communicates with one or more hidden layers where the processing is done by a system of weighted connections and activation functions. Then the hidden layers are linked to an output layer in order to output results of the aforementioned processing. Neural networks have a high number of neurons that should work in parallel, and the activation functions are included in these neurons. While each neuron includes an activation function, gain made from the use of resources by this function impacts the whole system.

In the state of the art, nonlinear activation functions are implemented by using Look-Up-Table (LUT) or curve fitting methods. LUTs use unnecessarily high amount of memory elements during implementation. Polynomial fitting methods, on the other hand, utilize hardware resources and cause processing delays. Especially when the number of neurons increases, designs implemented with these two methods cause excessive power consumption.

Application number US2020034714A1 was found during the literature review in the state of the art. In this application, it is mentioned that the error value was decreased by means of an activation function by utilizing a piecewise linear unit with different slopes in three sections. However, in the application, it is not mentioned that piecewise linear functions are utilized in both the training and the assessment of the neural networks. On the other hand, there is not an explanation regarding low resource usage and saving power by not using memory elements, and eliminating the need multiplication elements completely by using shift operations.

As a result, there is need for an improvement in the related field due to the aforementioned disadvantages and the insufficiency of present solutions about the subject.

### SUMMARY

The main objective of the invention is to save resource and power by not using block memory elements (LUT, Block RAM etc.) or distributed RAM for activation function in the implementation of artificial neural networks. It is to completely eliminate the need for resource consuming multiplication process by simple shift operations while nonlinear activation functions are approximated by piecewise functions. As each neuron includes an activation function, gain made from the use of resources impacts the whole system.

Being inspired from the existing situations, the objective of the invention is to resolve the aforementioned problems.

In order to achieve the aforementioned objectives, the invention is a method which does not utilize memory elements or LUTs in the hardware implementation of nonlinear activation functions of artificial neural networks, and which eliminates the need for multiplication elements, comprising the steps of:
determining the slopes of the piecewise lines approximating the nonlinear activation function so that their slopes are to be powers of 2, and the coordinates of the breaking points of the function,
calculating the absolute value vector of the input value of the activation function to work on the positive x axis according to the symmetrical feature of the activation function for the ease of process,
determining the area to which the piecewise function of the input value of the activation function belongs,
applying the slope value determined as power of 2 of the region determined according to the input value of activation function by arithmetic shifting method and adding the extension of the line determining this region with the value at the point where the y axis intersects,
updating the value which is acquired in the above steps according to the symmetrical feature of the function in the situations where the input value is negative.

The structural and characteristic features and all the advantages of the invention will be clearly comprehensible by means of the following figures and the detailed description written by referring to those figures and thereby the assessment should be made by considering these figures and the detailed description.

### BRIEF DESCRIPTION OF THE DRAWINGS

FIG. 1 is a view of the general artificial neural network structure consisting of an input layer, hidden layers, and an output layer, respectively.

FIG. 2 is a view of the approximation to the nonlinear activation function acquired from a single neuron of any one layer by piecewise linear function.

FIG. 3 is a sample view of left and right arithmetic shift operations, respectively.

FIG. 4 is a graph regarding the approximation to the nonlinear Logarithmic-Sigmoid activation function taken as a sample by piecewise function.

FIG. 5 is a graph regarding the approximation to the nonlinear Tangent-Sigmoid activation function taken as a sample by piecewise function.

FIG. 6 is a graph regarding the approximation to the nonlinear Radial-Basis activation function taken as a sample by piecewise function.

FIG. 7, is a performance comparison of the Logarithmic-Sigmoid activation function used in Digital Predistortion design and the piecewise linear function approximating this function according to the increasing number of neurons.

FIG. 8 is a performance comparison of the Tangent-Sigmoid activation function used in Digital Predistortion design and the piecewise linear function approximating this function according to the increasing number of neurons.

FIG. 9 is a performance comparison of the Radial-Basis activation function used in Digital Predistortion design and the piecewise linear function approximating this function according to the increasing number of neurons.

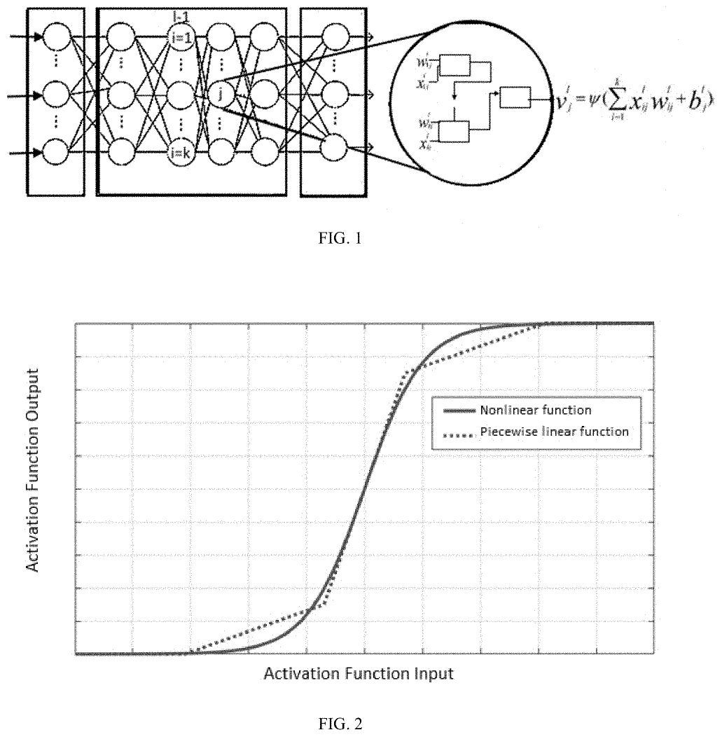

### DETAILED DESCRIPTION OF THE EMBODIMENTS

In this detailed description, preferred embodiments of the method for low resource and low power consuming implementation of nonlinear activation functions of artificial neural networks of the invention, only for a better understanding of the subject.

The subject of the invention, in general, relates to a method providing approximation to nonlinear activation functions of neural networks by piecewise linear functions. In the method of the invention, simple shift operations are used instead of power consuming multipliers without using memory elements.

Let L be the number of layers in a neural network and wᵢⱼ^{l} be the weight of the connection in the l^{th} layer from i^{th} neuron of the (l−1)^{th} layer to j^{th} neuron of the l^{th} layer and bⱼ^{l} be the bias vector of the j^{th} neuron of the l^{th} layer. Let xᵢⱼ^{l} be the input signal from the i^{th} neuron of the (l−1)^{th} layer to the j^{th} neuron of the l^{h} layer of the neural network and ψ be the activation function of a neuron, and vⱼ^{l} be the output of the j^{th} neuron in the l^{th} layer as shown in the following equation:

vⱼ^{l}=ψ(Σᵢ₌₁^{k}xᵢⱼ^{l}wᵢⱼ^{l}+bⱼ^{l})k:# of the neurons in the (l−1)^{th} layer (1)

The activation function determines the output of the neural network model, its accuracy, and also the computational efficiency of the training of a model. Activation functions also have a major effect on the neural network's ability to converge and the convergence rate, so when building a model and training a neural network, the selection of activation functions has a critical importance.

In the method of the invention, nonlinear activation functions of neural networks are approximated by piecewise linear functions. As an example, it is visible in FIG. 2 that the nonlinear function is approximated by piecewise linear function. The number of linear lines could be more than three for a better approximation and the value of slopes could be changed according to design requirements.

The equation of any straight lines can be expressed as y=mx+n where m represents the slope of the line, x and y represent the coordinates of the points on the line, n represents a constant number. In the method of the invention, in the approximating piecewise linear functions, x represents the input value of the activation function, while y represents the output value of the activation function.

The slopes of these lines are chosen to be as powers of 2 so that arithmetic shift operations can be used in digital implementation of these functions. Arithmetic shifts are efficient ways to perform multiplication or division of signed (determined) integers by powers of 2. Shifting left by n bits on a signed or unsigned binary number has the effect of multiplying it by 2ⁿ and shifting right by n bits has the effect of dividing it by 2ⁿ. These operations result in an acceptable accuracy for many applications. In the literature of digital design, “<<” expresses the binary left shift operator and “>>” expresses the binary right shift operator.

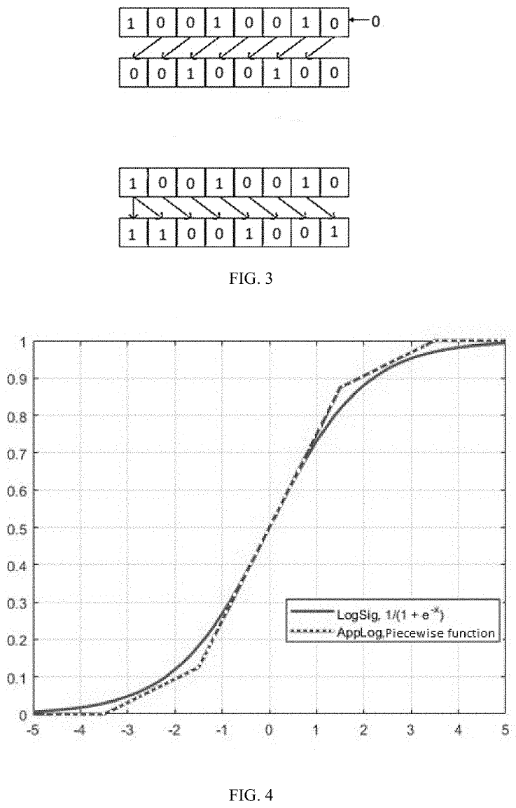

In the binary system, a left arithmetic shift means moving each bit to the left by one. While writing the binary numbers, the digit on the far right is called the least significant bit (LSB) and the digit on the far left is called the most significant bit (MSB). During left shifting operation, the vacant least significant bit is filled with zero and the most significant bit is discarded. A right arithmetic shift, on the other hand, moves each bit to the right by one. In this case, the least significant bit is discarded and the vacant most significant bit is filled with the value of the previous most significant one as shown in FIG. 3.

Steps of the method of the invention comprise of:
Determining the slopes of the piecewise lines approximating the nonlinear activation function so that their slopes are to be powers of 2, and the coordinates of the breaking points of the function,
calculating the absolute value vector of the input value of the activation function to work on the positive x axis according to the symmetrical feature of the activation function for the ease of process,
determining the area to which the piecewise function of the input value of the activation function belongs,
applying the slope value determined as power of 2 of the region determined according to the input value of activation function by arithmetic shifting method and adding the extension of the line determining this region with the value at the point where the y axis intersects,
updating the value which is acquired in the above steps according to the symmetrical feature of the function in the situations where the input value is negative.

For the approximated nonlinear activation functions Logarithmic-Sigmoid, Tangent-Sigmoid and Radial-Basis functions are selected as samples.

Approximation to the Logarithmic-Sigmoid Function by Piecewise Linear Functions

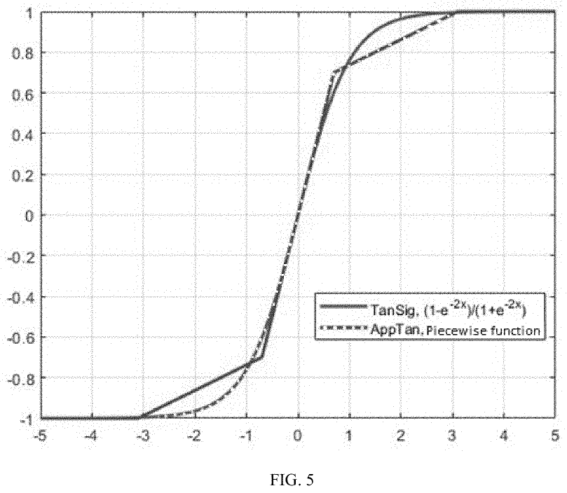

As can be seen in FIG. 4, since this function is symmetrical with respect to the point (0, 0.5), the positive x axis has been processed. The coordinates of the breaking points of the lines according to the positive x axis from small value to large are represented by x₁ and x₂.

The equations of a sample piecewise linear functions are given in Table 1.

TABLE 2
The equations of Piecewise LinearLogarithmic-
Sigmoid activation function

| | |
|---|---|
| y = 0 | x ≤ −x₂ |
| y = m₁x + n₁ | −x₂ < x < −x₁ |
| y = m₂x + n₂ | −x₁ ≤ x < x₁ |
| y = m₃x + n₃ | x₁ ≤ x < x₂ |
| y = 1 | x₂ ≤ x |

Sample values: m₁ = m₃ = 2⁻⁴, m₂ = 2⁻², x₁ = 1.5, x₂ = 3.5, n₁ = 0.2188, n₂ = 0.5, n₃ = 0.7813

FPGA (Field Programmable Gate Array) Implementation of Piecewise Linear Function Approximated to Logarithmic-Sigmoid Activation Function (FIG. 4)
1) The input of the activation function is represented by act_in.
2) The absolute value of the act_in value is taken and expressed by act_in_abs. It is assumed that the graph of this function shifts 0.5 down on y axis.

act_in_abs<=|act_in|
3) If act_in_abs is between 0 and x₁, 2 bits are discarded from the LBS of the act_in_abs vector and 2 zeros are added to the MBS of the act_in_abs vector. Since the act_in_abs is positive, the MSB is filled with zeros. This means dividing the act_in_abs value by 4 since m₂=2⁻².

If 0≤act_in_abs<x₁,act_out_abs<=(act_in_abs>>2)
4) If act_in_abs is between x₁ and x₂, 4 bits are discarded from the LBS of the act_in_abs vector and 4 zeros are added to the MBS of the act_in_abs vector. Since the act_in_abs is positive, the MSB is filled with zeros. This means dividing the act_in_abs value by 16 since m₃=2⁻⁴. The resulting outcome is summed with n₃−0.5 since it is assumed that the function graph shifts down on the y axis by 0.5.

If x₁≤act_in_abs<x₂,(act_in_abs>>4)+(n₃−0.5)
5) If the act_in_abs value is bigger than x₂, the result is 0.5.

If x₂≤act_in_abs,act_out_abs<=0.5
6) If the MSB value of the act_in is “0”, in other words, if act_in has a positive value, the calculated value of the act_out_abs in the previous steps is assigned to act_out which is the output of the activation function without a change. Otherwise, the negative value of the act_out_abs is calculated approximately by logical “not” operation and it is assigned to act_out which is the output of the activation function. Thereby, the function output is calculated for the input value in the negative area of the x axis.

If act_in>0,act_out<=act_out_abs else act_out<=not (act_out_abs)
7) In order to shift the graph to the point of 1 on the y axis like the original graph, the output of the activation function is summed with 0.5.

act_out<=act_out+0.5

Approximation to the Tangent-Sigmoid Function by Piecewise Linear Functions

As can be seen in FIG. 5, since this function is symmetrical with respect to the origin point, the positive x axis has been processed. The coordinates of the breaking points of the lines according to the positive x axis from the smaller value to larger are represented by and x₁ and x₂, respectively.

The equations of a sample piecewise linear functions are given in Table 1.

TABLE 1
The equations of approximated Tangent-
Sigmoid activation function

| | |
|---|---|
| y = −1 | x ≤ −x₂ |
| y = m₁x + n₁ | −x₂ < x < −x₁ |
| y = m₂x | −x₁ ≤ x < x₁ |
| y = m₃x + n₂ | x₁ ≤ x < x₂ |
| y = 1 | x₂ ≤ x |

Sample values: m₁ = m₃ = 2⁻³, m₂ = 2⁰, x₁ = 0.7, x₂ = 3.1, n₁ = −0.6125, n₂ = 0.6125

FPGA Implementation of Piecewise Linear Functions Approximated to Tangent-Sigmoid Activation Function (FIG. 5)
1) The input of the activation function is represented by act_in.
2) The absolute value of the act_in value is taken and expressed by act_in_abs.

act_in_abs<=|act_in|
3) If act_in_abs is between 0 and x₁, act_in_abs is taken as the output since m₂=2⁰.

If 0≤act_in_abs<x₁,act_out_abs<=act_in_abs
4) If act_in_abs is between x₁ and x₂, 3 bits are discarded from the LBS of the act_in_abs vector and 3 zeros are added to the MBS. Since the act_in_abs is positive, the MSB is filled with zeros. This means dividing the act_in_abs value by 8 since m₃=2⁻³. Then, the resulting outcome is summed with n₂.

If x₁≤act_in_abs<x₂,act_out_abs<=(act_in_abs>>3)+n₂
5) If the act_in_abs value is bigger than x₂, the result is 1.

If x₂≤act_in_abs,act_out_abs<=1
6) If the MSB value of the act_in is “0”, in other words, if act_in has a positive value, the calculated value of the act_out_abs in the previous steps is assigned to act_out which is the output of the activation function without a change. Otherwise, the negative value of the act_out_abs is calculated approximately by logical “not” operation and it is assigned to act_out which is the output of the activation function. Thereby, the function output is calculated for the input value in the negative area of the x axis.

If act_in>0,act_out<=act_out_abs else act_out<=not (act_out_abs)

Approximation to the Radial-Basis Function by Piecewise Linear Functions

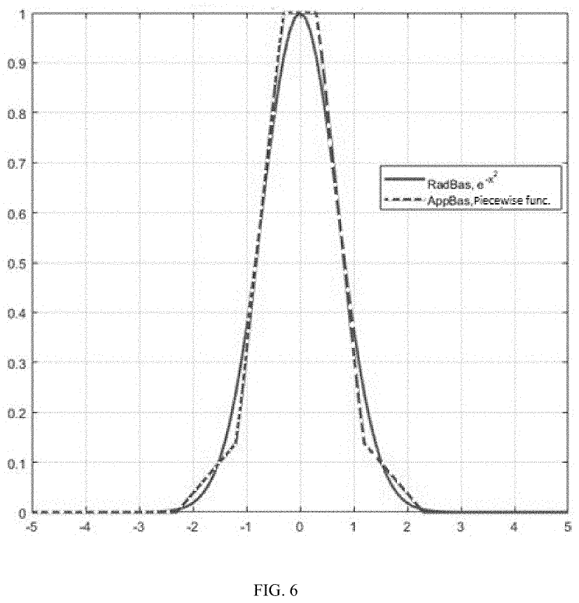

As can be seen in FIG. 6, since this function is symmetrical with respect to the y axis, the positive x axis has been processed. The coordinates of the breaking points of the lines according to the positive x axis from the smaller value to larger are represented by x₁, x₂ and x₃, respectively.

The equations of a sample piecewise linear functions are given in Table 1.

TABLE 3
The equations of approximated Radial-Basis activation function

| | |
|---|---|
| y = 0 | x ≤ −x₃ |
| y = −m₂x + n₂ | −x₃ < x ≤ −x₂ |
| y = −m₁x + n₁ | −x₂ < x ≤ −x₁ |
| y = 1 | −x₁ < x ≤ x₁ |
| y = m₁x + n₁ | x₁ < x ≤ x₂ |
| y = m₂x + n₂ | x₂ < x ≤ x₃ |
| y = 0 | x₃ < x |

Sample values: m₁ = −2⁰, m₂ = −2⁻³, x₁ = 0.32, x₂ = 1.18, x₃ = 2.3, n₁ = 1.32, n₂ = 0.2875

FPGA Implementation of Piecewise Linear Functions Approximated to Radial-Basis Activation Function (FIG. 6)
1) The input of the activation function is represented by act_in.
2) The absolute value of the act_in value is taken and expressed by act_in_abs.

act_in_abs<=act_in
3) If the act_in_abs value is between 0 and x₁, the result is 1.

If 0≤act_in_abs≤x₁,act_out_abs<=1
4) If the act_in_abs value is between x₁ and x₂, the negative value of the act_in_abs value is calculated by the logical “not” operation since m₁=−2⁰, and the resulting outcome is summed with n₁.

If x₁<act_in_abs≤x₂,act_out_abs<=not (act_in_abs)+n₁
5) If the act_in_abs value is between x₂ and x₃, 3 bits are discarded from the LBS of the act_in_abs vector and 3 zeros are added to the MBS of the act_in_abs vector. Since the act_in_abs value is positive, the MSB is filled with zeros. Then the negative value is calculated approximately by the logical “not” operation. This means dividing the act_in_abs value by 8 and calculating the negative value since m₂=−2⁻³. Then, the resulting outcome is summed with n₂.

If x₂<act_in_abs≤x₃,act_out_abs<=not (act_in_abs>>3)+n₂
6) If the act_in_abs value is bigger than x₃, the result is 0.

If x₃≤act_in_abs,act_out_abs<=0
7) Since this function is symmetrical with regard to the y axis, the act_out_abs value which is calculated in the previous steps gives the act_out value which is the output of the activation function.

act_out<=act_out_abs

Backpropagation network is the most frequently used learning algorithm among artificial neural systems. In this algorithm, the weights are updated by using gradient descent technique so that the error function is minimized and the actual output is approximated to the target output. This process continues until the network reaches the pre-determined level of accuracy when adequate responds for the training model are generated.

Nonlinear activation functions are differentiable. This property is needed to compute error gradients with respect to weights while performing backpropagation optimization in the training process. Then, the weights are updated towards the opposite direction of the gradient vector.

In the method of the invention, approximation to the nonlinear activation functions by piecewise linear functions is used both in the training and the evaluation stages of a neural network. The experiments show that if the approximation method by the proposed piecewise functions is not applied identically at the stage of training, the network implemented by the proposed method does not provide enough performance. Thus, the proposed method, unlike the literature, comprises alteration of the training stage according to the approximation to the linear activation functions proposed in this document Digital Predistortion (DPD) method is used as a sample application. This method is used in order to minimize the nonlinear impacts caused by power amplifiers (PA) used in wireless communication devices on specifically high output powers. In the method of DPD, the signal transmitted in the baseband is distorted digitally in a manner that it is linear at the target PA output There are different methods in the literature for distortion, in our case study YSA was chosen for DPD and the system was linearized by digital distortion. In the ANN training used in the method of the invention, standard activation functions used in the software utilizing a smart unit with ANN training algorithm support and the relevant operations regarding these were used by changing in accordance with the approximation method by the proposed piecewise linear functions.

At the testing stage of the method of the invention, Orthogonal Frequency Division Multiplexing (OFDM) based signal wave form was used. Performance of the DPD implementation is examined by calculating the signal quality at PA output and the FPGA resource utilization rate. The signal quality is evaluated by measuring the Error Vector Magnitude (EVM).

Sₘₐₓ being the maximum amplitude, N being the number of OFDM subcarriers [symbol] and Xₖ being the k^{th} received and original symbols respectively, Error Vector Magnitude (EVM) is calculated by the following formula.

$$EVM = ( 1 \text{/} {S}_{max} ) {( \frac{1}{N} {\sum }_{k = 1}^{N} {\vert - {X}_{k} \vert}^{2} )}^{1 \text{/} 2} \qquad ( 2 )$$

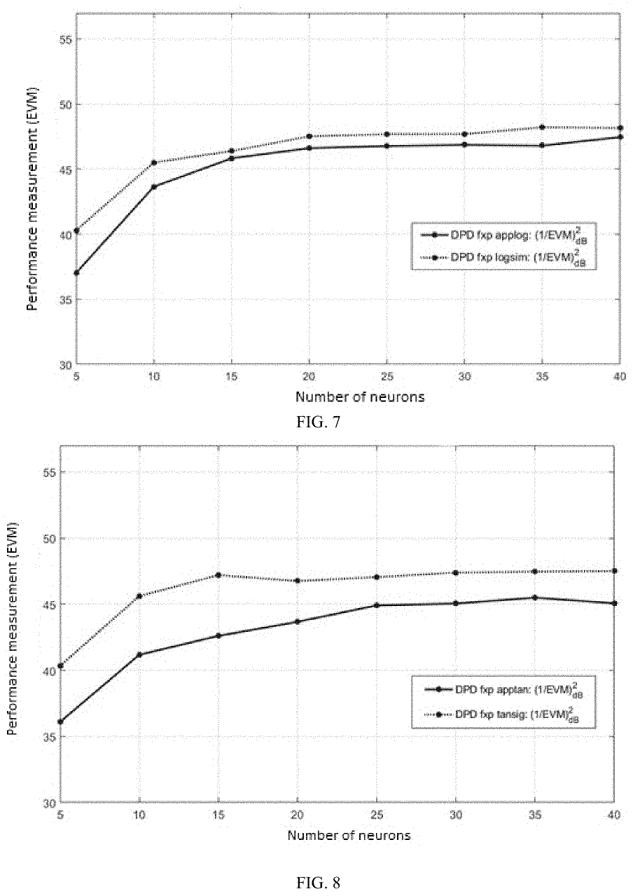

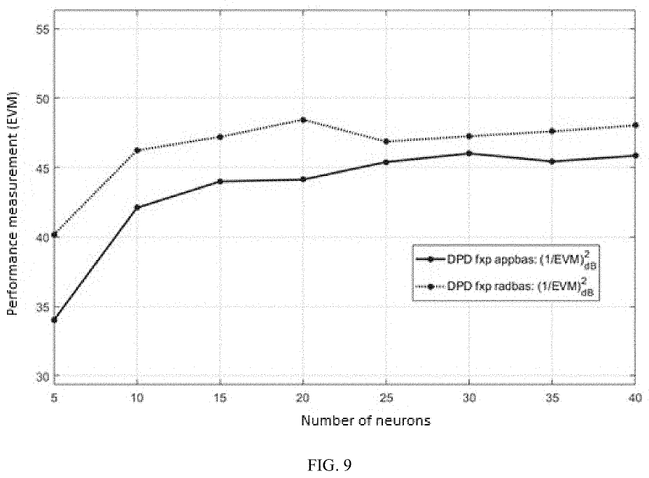

The activation function performance in DPD system is measured by comparing two different designs. The first design has the original non-linear activation function. The second design, on the other hand, has the piecewise linear activation function which is the method of the invention. The measurements show that there is acceptable performance degradation in the range of a few dBs in terms of the EVM metric when compared to the original nonlinear activation functions. For example, when the number of neurons in the hidden layer is set to 20, there is 0.9 dB EVM difference between the designs with the original Logarithmic-Sigmoid activation function and its approximated version as shown in FIG. 7. Similarly, as shown in FIGS. 8 and 9, EVM differences of 3.09 dB and 4.31 dB are formed respectively between designs with Tangent-Sigmoid and Radial-Basis activation functions and designs approximated to the activation functions. The loss of performance with the proposed method tends to decrease with the increasing number of neurons.

In the tests performed with the proposed method, it was observed that significant achievements were made in the hardware implementation compared to the acceptable losses of performance in practical applications. Saving in the amount of FPGA resource utilization of the activation function formed by the proposed method is explained in detail in the reference paper [1].

### REFERENCES

[1] S. Yeşil, C. Şen and A. Ö. Yilmaz, “Experimental Analysis and FPGA Implementation of the Real Valued Time Delay Neural Network Based Digital Predistortion,” 2019 26th IEEE International Conference on Electronics, Circuits and Systems (ICECS), Genoa, Italy, 2019, pp. 614-617.

1. A method for low resource and low power consuming implementation of nonlinear activation functions of artificial neural networks, wherein high resource and high power consuming memory elements comprising a LUT and a Block RAM or a distributed RAM are not used, and the method comprises:
determining slopes of piecewise lines approximating a nonlinear activation function, wherein the slopes of the piecewise lines are to be powers of two, and coordinates of breaking points of the nonlinear activation function,
calculating an absolute value vector of an input value of the nonlinear activation function to work on a positive x axis according to a symmetrical feature of the nonlinear activation function,
determining an area, wherein a piecewise function of the input value of the nonlinear activation function belongs to the area,
applying a slope value determined as power of two of a region determined according to the input value of the nonlinear activation function by an arithmetic shifting method and adding an extension of a line determining the region with a value at a point where a y axis intersects,
updating the value acquired in the above steps according to the symmetrical feature of the nonlinear activation function in situations where the input value is negative.

2. The method according to claim 1, wherein the artificial neural networks are applied at stages of both training and evaluation.
